(19) United States
(12) Patent Application Publication
(10) Pub. No.: US 2014/0280980 A1
(43) Pub. Date: Sep. 18, 2014

(54) Connecting Consumers with Providers

(71) Applicant: Roy Schoenberg, Boston, MA (US)

(72) Inventor: Roy Schoenberg, Boston, MA (US)

(21) Appl. No.: 13/796,755

(22) Filed: Mar. 12, 2013

(51) Int. Cl. H04L 29/06

(52) U.S. Cl. CPC H04L 65/1066
USPC 709/227

(57) ABSTRACT

A computer-implemented method includes receiving, from a computing device used by a first service provider, a request to transfer a communication connection established between a device used by a consumer of services and the device used by the first service provider, with the transfer request directed to an available second, service provider; determining, by a brokerage system, one or more available second service providers; establishing, by the brokerage system based on a selected second service provider, a second communication channel with a device used by the selected second service provider; and causing, by the brokerage system, a disconnection of the first communication channel and a transfer of the connection of the first communication channel from the first communication channel to the second communication channel.

### BACKGROUND

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes receiving, from a computing device used by a first service provider, a request to transfer a communication connection established between a device used by a consumer of services and the device used by the first service provider, with the transfer request directed to an available second, service provider; determining, by a brokerage system, one or more available second service providers; establishing, by the brokerage system based on a selected second service provider, a second communication channel with a device used by the selected second service provider; and causing, by the brokerage system, a disconnection of the first communication channel and a transfer of the connection of the first communication channel from the first communication channel to the second communication channel.

Implementations of the disclosure may include one or more of the following features. In some implementations, the method includes receiving, from the device used by the first service provider, information indicative of a selection of one of the one or more available second service providers. In other implementations, one or more of the device used by the consumer of services, the device used by the first service provider, and the device used by the second service provider comprises a telephonic device. In still other implementations, one or more of the device used by the consumer of services, the device used by the first service provider, and the device used by the second service provider comprises a computing device. In yet other implementations, one or more of the first communication channel and the second communication channel comprises a voice-based communication channel.

In still other implementations, one or more of the first communication channel and the second communication channel comprises a text-based communication channel. In some implementations, the connection is a first connection, and the method further comprises: establishing the first connection with the device used by the consumer of services; establishing a second connection with the device used by the first service provider; and joining the first connection with the second connection to establish the first communication channel between the device used by the consumer of services and the device used by the first service provider. In still other implementations, receiving the request to transfer comprises: receiving a request to transfer the communication with the consumer of services to an available second service provider associated with one or more attributes that define a suitable second service provider; wherein determining, by the brokerage system, the one or more available second service providers comprises: searching, by the brokerage system, a data repository for information indicative of the one or more available second service providers that are associated with at least one of the one or more specified attributes.

In another aspect of the disclosure, one or more machine-readable media are configured to store instructions that are executable by one or more processing devices to perform operations including receiving, from a computing device used by a first service provider, a request to transfer a communication connection established between a device used by a consumer of services and the device used by the first service provider, with the transfer request directed to an available second, service provider; determining one or more available second service providers; establishing, based on a selected second service provider, a second communication channel with a device used by the selected second service provider; and causing a disconnection of the first communication channel and a transfer of the connection of the first communication channel from the first communication channel to the second communication channel. Implementations of this aspect of the present disclosure may include one or more of the foregoing features.

In still another aspect of the disclosure, an electronic system includes one or more processing devices; and one or more machine-readable media configured to store instructions that are executable by the one or more processing devices to perform operations including: receiving, from a computing device used by a first service provider, a request to transfer a communication connection established between a device used by a consumer of services and the device used by the first service provider, with the transfer request directed to an available second, service provider; determining one or more available second service providers; establishing, based on a selected second service provider, a second communication channel with a device used by the selected second service provider; and causing a disconnection of the first communication channel and a transfer of the connection of the first communication channel from the first communication channel to the second communication channel. Implementations of this aspect of the present disclosure may include one or more of the foregoing features.

### BRIEF DESCRIPTION OF THE FIGURES

FIG. 1 shows a system for transferring communications.

FIG. 2 is an example of a graphical user interface presented to users of the system.

FIG. 3 is an example of a graphical user interface presented to users of the system.

FIGS. 4 and 5 are flow charts of processes used in the system.

FIG. 6 is a block diagram of a computer (computer system) showing exemplary components that can be used for the brokerage system and/or client devices.

### DETAILED DESCRIPTION

The system described below provides a communication platform for transferring a communication with a consumer from one service provider to another service provider. There are various types of service providers, including, e.g., medical service providers. In an example, a patient calls through a telephonic communication channel (web or switched-network based) into a brokerage system to speak with a service provider, e.g., a physician, about the patient's medical condition. The physician and the patient engage in a telephonic consultation. During the consultation, the physician determines that the patient should consult with another medical service provider, e.g., a specialist. Using the brokerage system, the physician who is engaged in the consultation may cause a transfer a connection of the established communication to a telephonic device used by the specialist.

For example, through a communication channel established by the brokerage system, the physician converses with the patient. During the conversation, the physician decides that consulting with a specialist would be helpful to the patient. The physician accesses the system described below and requests a consultation with an available specialist. The system identifies an available physician (i.e., specialist) and establishes a communication channel between computing devices used by the physician and by the specialist, respectively. Through the established communication channel, the physician debriefs the specialist on the patient's current medical condition. Following debriefing, the physician uses the system to establish a communication between devices used by the patient and the specialist, respectively. These devices include telephonic devices and/or computing devices. The physician also uses the system to transfer a connection of the communication channel established between the devices used by the physician and the patient, respectively, to the communication channel established between the devices used by the specialist and the patient, respectively.

FIG. 1 shows an example environment 100 for transferring communications. The environment 100 includes a computerized brokerage system or server 110 for making connections between consumer 120, at client device 122, and service providers 126, 130, at client devices 124, 128 over a network 106, e.g., the Internet or other types of networks. Client devices 122, 124, 128 can be any combination of, e.g., personal digital assistants, land-line telephones, cell phones, computer systems, media-player-type devices, and so forth. Client devices 122, 124, 128 enable consumer 120 and the service providers 126, 130 to input and to receive information as well as to communicate via video, audio, and/or text with each other.

System 110 may operate as a service running on web server 102. The components of system 110 and web server 102 may be integrated or distributed in various combinations as is known in the art. System 110 accesses one or more databases 118.

A communication channel is established through brokerage system 110 between client device 124 (e.g., used by service provider 126) and client device 122 (e.g., used by consumer 120). The communication channel includes two connections. The first connection is between client device 124 and brokerage system 110. The second connection is between client device 122 and brokerage system 110. During the communication with consumer 120, service provider 126 decides to transfer the communication with consumer 120 to service provider 130. Service provider 126 uses client device 124 to access brokerage system 110 and to request a transfer of the communication to service provider 130. In response to the request, brokerage system 110 establishes a communication channel with client device 128 to promote transfer of the consultation to client device 128. Brokerage system 110 transfers the communication to service provider 130 by transferring the second connection that is between client device 122 and brokerage system 110 to the communication channel that is established between client device 128 and brokerage system 110. Brokerage system 110 joins the second connection to the established communication channel between brokerage system 110 and client device 128. After completion of joining the second connection to the established communication channel, client devices 122, 128 are connected to each other through brokerage system 110, as described in further detail below.

To establish the communication channel with client device 128, brokerage system 110 accesses, from database 118, contact information for client device 128 used by service provider 130, including, e.g., a telephone number for client device 128, an Internet Protocol (“IP”) address of client device 128, and so forth. Using the contact information for client device 128, brokerage system 110 establishes a communication channel with client devices 122, 128. Brokerage system 110 implements the transfer functionality to transfer a connection of the communication channel between client devices 122, 126 to the communication channel established with client device 128.

Brokerage system 110 also includes an availability or presence tracking module 112 for tracking the availability of service providers 130. Availability or presence is tracked actively or passively. In an active system, one or more of the service providers 130 provides an indication to brokerage system 110 that the one or more service providers are available to be contacted by consumers 120 and/or by service providers 126 and an indication of the mode by which the provider may be contacted. In some examples of an active system, the provider's computer, phone, or other terminal device periodically provides an indication of the provider's availability (e.g., available, online, idle, busy) to the system 110 and a mode (e.g., text, voice, video, etc.) by which the provider can be engaged. In a passive system, brokerage system 110 presumes that the service provider 130 is available by the service provider's actions, including connecting to brokerage system 110 or registering the provider's local phone number with the system. In some examples of a passive system, the system 110 indicates the provider 130 to be available at all times until the provider logs off, except when the provider is actively engaged with a consumer 120 and/or with another service provider 126.

Providers are, however, often available at times that are not convenient for their consumers, for example, in the event of a last-minute cancellation. Providers also may be available during otherwise idle times, such as when home. The brokerage supplements existing provider availability to allow whichever providers are available at any given time engage in a consultation with another service provider and a consumer at the request of the other service provider. Instead of relying on the unlikely availability of a specific provider for any given consumer, the brokerage connects service provider 126 to all online providers 130 capable of addressing the needs of consumer 120. The brokerage has distinct features including the ability to engage in live communication with a suitable, selectable provider and the ability to do so at the request of another service provider 126.

The system assists service provider 126 in navigating to an appropriate service provider 130. Service provider 126 selects to transfer consumer 120 to the next available service provider 130 in a given service provider domain (e.g., service provider 126 can choose to connect to the next available dermatologist).

Brokerage system 110 provides information and services to service providers 126 in addition to connecting them with providers 130. The brokerage system 110 includes an access control facility 114, which manages and controls whether a given service provider 126 may access system 110 and what level or scope of access to the features, functions, and services system 110 will provide.

Brokerage system 110 facilitates communication between consumer 120 and one or more of providers 126, 130, enabling them to communicate, for example, via a data-network-facilitated video or voice communication channel (such as Voice over IP), land and mobile telephone network channels, and instant messaging or chat. The availability of one or more providers 130 is tracked, and at the instant another service provider 126 desires to transfer a communication to another provider, the system 110 determines whether a provider is available. If a particular provider 130 is available, the system 110 assesses the various modes of communication that are available (e.g., based on common modes and modes preferred by the provider) and transfers the communication to the provider 130 through one or more of the common modes of communication.

In addition, the system selects a mode of communication to use based in part on the relative utility of the various modes. The preferred mode for an engagement is for both the provider 126 and the provider 130 to use web-based consoles, as this allows each of the other modes to be used as needed. For example, the provider 126 and the provider 130 may launch chat sessions, voice calls, or video chats from within a web-based console. If the provider 130 is not available, the system 110 identifies other available providers 130 that would meet the needs of consumer 120 as determined by service provider 126. The system 110 enables the service provider 126 to send a message to the consumer's chosen provider. The service provider 126 can also have the system 110 contact the service provider 126 in the future when the chosen provider is available.

Referring now to FIG. 2, graphical user interfaces 131, 132 are presented to a consumer using brokerage system 110. At a first point in time, the consumer is engaged in a consultation with a service provider shown in portion 134 of graphical user interface 131. Graphical user interface 131 also displays portion 136 which includes an image of the consumer who is engaged in the consultation. At a second point in time, the brokerage system 110 transfers the communication with the consumer from the service provider who is represented in portion 134 to another, different service provider who is represented in portion 135 of graphical user interface 132. Graphical user interface 132 also includes portion 137 for displaying a representation of the consumer. Through graphical user interfaces 131, 132, the consumer is provided with visual representations of service providers with whom the consumer is engaged in consultations, e.g., prior to the transfer and following completion of the transfer.

Referring to FIG. 3, graphical user interface 138 is generated by brokerage system 110 and displayed for a service provider, e.g., when the service provider sends brokerage system 110 a request to transfer a communication to another service provider. Through graphical user interface 138, a transferring service provider can specify various criteria to be used in searching for a recipient service provider. A transferring service provider is a service provider who requests a transfer of a communication to another service provider (e.g., a recipient service provider). A recipient service provider is a service provider to whom a communication is transferred.

Graphical user interface 138 includes field 139a for input of information (e.g., criteria) indicative of a practice area to be used in searching for recipient service providers. Graphical user interface 138 includes field 139b for input of information (e.g., criteria) indicative of a provider type to be used in searching for recipient service providers. There are various provider types, including, e.g., a dermatologist, a cardiologist, a pathologist, and so forth. Graphical user interface 138 includes field 139c for input of information (e.g., criteria) indicative of a location (e.g., a country or state, as appropriate, in which service providers are licensed to practice medicine) to be used in searching for recipient service providers.

Following input of criteria into one or more of fields 139a, 139b, 139c, a transferring service provider selects control 143. Selection of control 143 causes a client device to send, to brokerage system 110, a request to search for service providers with attributes matching at least some of the information (e.g., criteria) specified in fields 139a, 139b, 139c. In response to the request, the brokerage system 110 identifies one or more service providers with attributes (e.g., as specified in a profile of service providers) matching at least some of the information (e.g., criteria) specified in fields 139a, 139b, 139c. The brokerage system 110 transmits, to the client device displaying graphical user interface 138, information for populating portion 144 of graphical user interface 138. Portion 144 is populated with information 146, 148 specifying recipient service providers to whom a consumer may be transferred. The service provider associated with information 146 is currently available to engage in a consultation with a consumer who is transferred to the service provider. Information 146 specifies that this service provider has no patients currently waiting for consultations with the service provider.

The service provider associated with information 148 is not currently available to engage in a consultation with a consumer who is transferred to the service provider. Information 148 specifies that this service provider has two patients currently waiting for consultations with the service provider. Even though the service provider associated with information 148 is not currently available for a consultation, the transferring service provider may still transfer the consumer to the service provider associated with information 148, e.g., to place the consumer in a queue of consumers who are waiting for consultations with this service provider. When the consumer becomes first in the queue, the transfer is complete and the consumer is transferred to the recipient service provider who has now become currently available for the consultation.

Graphical user interface 138 also includes portion 150 for entry of notes to be sent to a recipient service provider. A transferring service provider uses graphical user interface 138 to make a selection of a recipient service provider, e.g., by selecting a portion of graphical user interface 138 associated with one of information 146, 148. The transferring service provider also inputs into portion 150 notes to be sent to the selected, recipient service provider.

Graphical user interface 138 also includes control 152, selection of which causes the client device displaying graphical user interface 138 to send, to brokerage system 110, a request to transfer a communication with a consumer from transferring service provider (who is making the request) and to a selected recipient service provider. Upon receipt of the request, the brokerage system 110 transfers the communication to a device of the selected recipient service provider.

Referring now to FIG. 4, the brokerage system 110 tracks 160 the availability of recipient service providers (e.g., service provider 130). When a provider 130 logs 162 into system 110, the provider 130 indicates 164 (such as by setting a check box or selecting a menu entry or by responding to a voice prompt) to the tracking module 112 that he or she is available to interact with consumers 120 and/or providers 126. The provider 130 can also indicate 166 to the tracking module 112 (such as by setting a check box or selecting a menu entry or by responding to a voice prompt) the modes (e.g., telephone, chat, video conference) by which consumers 120 and/or providers 126 can be connected to the provider 130. Alternatively, the tracking module 114 determines 168 the capabilities of the terminals 124, 128 the providers 126, 130 use to connect to the system (for example, by using a terminal-based program to analyze the hardware configuration of each terminal). Thus, if a provider 130 connects to the system 110 by a desktop computer and the provider has a video camera connected to that computer, the tracking module 112 determines 168 that the provider 130 can be engaged by text (e.g., chat or instant messenger), voice (e.g., VoIP) or video conference. Similarly, if a provider 130 connects to the system using a handheld device such as a PDA, the tracking module 112 determines 168 that the provider 130 can be engaged by text or voice. The tracking module 112 can also infer 170 a provider's availability and modes of engagement by the provider's previously provided profile information and the terminal device through which the provider connects to the system.

Providers participating in the brokerage network can have several states of availability over time. States in which the provider may be available may include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states may include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The tracking module 112 transfers 172 information about the availability and the communication capability of the consumers 120 and the providers 126, 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 110 includes access control facilities 114 that control how service providers 126 access the system and to what extent or level the services provided by the system are made available to service providers 126. The system 110 also stores and provides access to consumer information (e.g., contact information, and preference/profile information to be described later). However, other consumer information would typically be not accessible to the service provider, such as credit rating information, financial information, and credit card information. Similarly, provider information (e.g., biographies, product and service information, and any information the provider wants to make available to consumers) can be made available. The access control facility 114 would prevent unauthorized access to this information.

While the system can assist provider 126 in identifying the most appropriate providers, it also allows provider 126 to filter the provider list based on his preference and access a view of a provider availability matrix that changes as providers go on and off line. Various criteria are used to filter the available providers. Basic details indicate preference for the type and gender of the provider and what modes of communication to be used. Provider 126 can also specify demographics including location and languages spoken. Qualifications may include years of experience and various other criteria. Provider 126 can also use a search box to search for a provider by name.

Providers 126 may select providers 130 according to the type of consultation that is sought and attributes of the provider, such as a geographical area where the provider is located. Various metrics within the provider profile (discussed below) can be used to define a list of providers that meet the consumer's preferences.

Once provider 126 enters search criteria, the results are shown on the web page. As mentioned, a list of providers is presented. This list may indicate each providers name and rating and whether the provider is available. For the selected provider, additional details are shown, including her picture, specialty, demographic information, what types of connections she can use for an engagement, and personal information. Tools allow the consumer to initiate or schedule an engagement and/or view a live video/audio.

FIG. 5 is a flow chart of example process 180 for transferring a communication between client devices 122, 124 to client devices 122, 128. Client device 124 is used by service provider 126, who is a transferring service provider. Client device 128 is used by service provider 130, who is a recipient service provider. Client device 122 is used by consumer 120. Process 180 includes client side processes 182, 184, 186 performed on client devices 128, 124, 122, respectively and a server side process 190 performed on brokerage system 110.

In operation, client device 122 sends (192) a request to brokerage system 110 for an available service provider to engage in a consultation with consumer 120. Brokerage system 110 receives (194) the request for an available service provider to engage in the consultation. In response, brokerage system 110 determines (196) one or more available service providers. In an example, consumer 120 requests available service providers associated with specified attributes that define a suitable service provider acceptable for the consultation, as previously described.

Client device 122 receives (198) information specifying the available service providers that match the specified attributes. Consumer 120 selects service provider 126 and client device 122 sends (200) to brokerage system 110 a request to establish a communication channel with client device 124 used by service provider 126. Brokerage system 110 receives (202) from client device 122 the request to establish the communication channel. Brokerage system 110 establishes (204) a first communication channel (i.e., communication channel 220) between client devices 122, 124. Communication channel 220 includes one connection 222 between client device 122 and brokerage system 110 and another connection 224 between client device 124 and brokerage system 110.

Through communication channel 220, consumer 120 and service provider 126 engage in a consultation. During the consultation, service provider 126 decides that consumer 120 should be transferred to another service provider, e.g., if service provider 126 decides that consumer 120 would benefit from engaging in a consultation with another, different service provider (e.g., a specialist and/or a service provider in a field of practice that differs from the field of practice of service provider 126). Client device 124 sends (205), to brokerage system 110, a request for recipient service providers to whom consumer 120 may be transferred. The request is for currently available recipient service providers and/or recipient service providers associated with attributes that satisfy one or more criteria indicative of a suitable recipient service provider.

Service provider 126 requests a recipient service provider 130 using numerous attributes associated with service provider 130, including, e.g., name information, attributes that service provider 126 has determined would be helpful in assisting consumer 120, and so forth. For example, if consumer 120 describes to service provider 126 that consumer 120 has concerns with a mole, service provider 126 sends to brokerage system 110 a request to transfer consumer 120 to a service provider having attributes indicative of dermatology expertise (e.g., a dermatologist).

Brokerage system 110 receives the request for recipient service providers. In response, brokerage system 110 identifies one or more service providers who are currently available to act as recipient service providers and/or who are qualified to act as recipient service providers (e.g., by having attributes that satisfy one or more criteria indicative of a suitable recipient service provider). Brokerage system 110 transmits (209), to client device 124), information indicative of the identified recipient service providers. Client device 124 receives (207) the information indicative of the identified recipient service providers. In response, service provider 126 (who is acting as a transferring service provider) makes a selection of one of the identified recipient service providers to whom consumer 120 is transferred. Client device 124 sends (206), to brokerage system 110, a transfer request to transfer consumer 120 to the selected recipient service provider, who is service provider 130. The transfer request may also include information to debrief service provider 130 on the symptoms and/or conditions of consumer 120. In particular, client device 124 receives input selecting a recipient service provider and generates a transfer request for a communication channel, namely, communication channel 226, for which to transfer connection 222 of communication channel 220.

Brokerage system 110 receives (208) the transfer request. In response, brokerage system 110 establishes (210) a second communication channel (i.e., communication channel 226) between client devices 122, 128. Communication channel 226 includes two connections, connection 222 between client device 122 and brokerage system 110, and another connection 228 between client device 128 and brokerage system 110. Brokerage system 110 establishes communication channel 226 by transferring (212) connection 222 from communication channel 220 to communication channel 226. Once connection 222 is moved to communication channel 226, brokerage system 110 drops connection 224 from brokerage system 110 and/or terminates communication channel 220. By transferring connection 222 from communication channel 220 to communication channel 226, client device 122 joins (216) communication channel 226. Brokerage system 110 establishes communication channel 226 (at least in part) by generating connection 228 with client device 128 and joining connection 228 to communication channel 226.

Brokerage system 110 generates connection 228 using contact information for client device 128. When brokerage system 110 receives from client device 124 a request to transfer the communication over communication channel 220 with consumer 120 to recipient service provider 130 (who is using client device 128), brokerage system 110 retrieves, from database 118, contact information of client device 128 used by recipient service provider 130. Contact information includes an online screen name, a telephone number, an IP address and any other identifying information which may be used to establish a connection with client device 128.

By generating connection 228, client device 128 joins (214) communication channel 226. Communications channels 220, 226 are one or more of telephonic communication channels (e.g., when client devices 122, 124, 128 are telephonic devices and when client devices 122, 124, 128 are computing devices with telephonic capabilities), a network-based communication channel (e.g., via the Internet when client devices 122, 124, 128 are computing devices), and so forth. There are various types of network-based communication channels, including, e.g., instant messaging communication channels, video-conferencing communication channel, voice over Internet protocol communication channels, and so forth.

In a variation of FIG. 5, transferring service provider 126 selects recipient service provider 130 and client device 124 sends to brokerage system 110 a request to establish a communication channel with client device 128 used by recipient service provider 130. Brokerage system 110 receives from client device 124 used by transferring service provider 126 the request to establish the communication channel. In response, brokerage system 110 establishes a debriefing communication channel (not shown) between client devices 124, 128 to enable transferring service provider 126 to debrief recipient service provider 130 on a condition of consumer 120. The debriefing communication channel between client devices 124, 128 includes two connections, one connection between client device 128 and brokerage system 110 and another connection (not shown) between client device 124 and brokerage system 110.

Through the debriefing communication channel established between client devices 124, 128, transferring service provider 126 debriefs recipient service provider 130 on the symptoms and/or conditions of consumer 120. Following the debriefing, transferring service provider 126 sends the transfer request to transfer consumer 120 to recipient service provider 130 (i.e., by moving connection 222 from communication channel 220 to communication channel 226). Following receipt of the transfer request, brokerage system 110 establishes communication channel 226 by moving connection 222 to communication channel 226 and by moving the connection between client device 128 and brokerage system 110 (in the debriefing communication channel) to communication channel 226. In still another variation, following the debriefing over the debriefing communication channel established between client devices 124, 128, brokerage system 110 establishes communication channel 226 by moving connection 222 to communication channel 226 and by generating a new connection between client device 128 and brokerage system 110 and joining this new connection to communication channel 226.

FIG. 6 is a block diagram of components 260 of the engagement brokerage system. User devices 262 can be any sort of computing device capable of taking input from a user and communicating over a network (not shown) with server 110 and/or with other client devices. For example, user device 262 can be a mobile device, a desktop computer, a laptop, a cell phone, a personal digital assistant (“PDA”), a server, an embedded computing system, a mobile device and so forth. User devices 262 include monitor 264 which render visual representations of interface 266.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device 262 via interfaces 266, including, e.g., graphical user interfaces. Interfaces 266 can be any type of interface capable of receiving information over a network, such as an Ethernet interface, a wireless networking interface, a fiber-optic networking interface, a modem, and so forth. Server 110 also includes a processor 268 and memory 270. A bus system (not shown), including, for example, a data bus and a motherboard, can be used to establish and to control data communication between the components of server 110.

Processor 268 may include one or more microprocessors. Generally, processor 268 may include any appropriate processor and/or logic that is capable of receiving and storing data, and of communicating over a network (not shown). Memory 270 can include a hard drive and a random access memory storage device, such as a dynamic random access memory, machine-readable media, or other types of non-transitory machine-readable storage devices.

Components 260 also include storage device 272, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving, from a computing device used by a first service provider, a request to transfer a communication connection established between a device used by a consumer of services and the device used by the first service provider, with the transfer request directed to an available second, service provider;
determining, by a brokerage system, one or more available second service providers;
establishing, by the brokerage system based on a selected second service provider, a second communication channel with a device used by the selected second service provider; and
causing, by the brokerage system, a disconnection of the first communication channel and a transfer of the connection of the first communication channel from the first communication channel to the second communication channel.

2. The computer-implemented method of claim 1, further comprising:
receiving, from the device used by the first service provider, information indicative of a selection of one of the one or more available second service providers.

3. The computer-implemented method of claim 1, wherein one or more of the device used by the consumer of services, the device used by the first service provider, and the device used by the second service provider comprises a telephonic device.

4. The computer-implemented method of claim 1, wherein one or more of the device used by the consumer of services, the device used by the first service provider, and the device used by the second service provider comprises a computing device.

5. The computer-implemented method of claim 1, wherein one or more of the first communication channel and the second communication channel comprises a voice-based communication channel.

6. The computer-implemented method of claim 1, wherein one or more of the first communication channel and the second communication channel comprises a text-based communication channel.

7. The computer-implemented method of claim 1, wherein the connection is a first connection, and wherein the method further comprises:
establishing the first connection with the device used by the consumer of services;
establishing a second connection with the device used by the first service provider; and
joining the first connection with the second connection to establish the first communication channel between the device used by the consumer of services and the device used by the first service provider.

8. The method of claim 1, wherein receiving the request to transfer comprises:
receiving a request to transfer the communication with the consumer of services to an available second service provider associated with one or more attributes that define a suitable second service provider;
wherein determining, by the brokerage system, the one or more available second service providers comprises:
searching, by the brokerage system, a data repository for information indicative of the one or more available second service providers that are associated with at least one of the one or more specified attributes.

9. One or more machine-readable media configured to store instructions that are executable by one or more processing devices to perform operations comprising:
receiving, from a computing device used by a first service provider, a request to transfer a communication connection established between a device used by a consumer of services and the device used by the first service provider, with the transfer request directed to an available second, service provider;
determining one or more available second service providers;
establishing, based on a selected second service provider, a second communication channel with a device used by the selected second service provider; and
causing a disconnection of the first communication channel and a transfer of the connection of the first communication channel from the first communication channel to the second communication channel.

10. The one or more machine-readable media of claim 9, wherein the operations further comprise:
receiving, from the device used by the first service provider, information indicative of a selection of one of the one or more available second service providers.

11. The one or more machine-readable media of claim 9, wherein one or more of the device used by the consumer of services, the device used by the first service provider, and the device used by the second service provider comprises a telephonic device.

12. The one or more machine-readable media of claim 9, wherein one or more of the device used by the consumer of services, the device used by the first service provider, and the device used by the second service provider comprises a computing device.

13. The one or more machine-readable media of claim 9, wherein one or more of the first communication channel and the second communication channel comprises a voice-based communication channel.

14. The one or more machine-readable media of claim 9, wherein one or more of the first communication channel and the second communication channel comprises a text-based communication channel.

15. The one or more machine-readable media of claim 9, wherein the connection is a first connection, and wherein the operations further comprise:
establishing the first connection with the device used by the consumer of services;
establishing a second connection with the device used by the first service provider; and
joining the first connection with the second connection to establish the first communication channel between the device used by the consumer of services and the device used by the first service provider.

16. An electronic system comprising:
one or more processing devices; an
one or more machine-readable media configured to store instructions that are executable by the one or more processing devices to perform operations comprising:
receiving, from a computing device used by a first service provider, a request to transfer a communication connection established between a device used by a consumer of services and the device used by the first service provider, with the transfer request directed to an available second, service provider;
determining one or more available second service providers;
establishing, based on a selected second service provider, a second communication channel with a device used by the selected second service provider; and
causing a disconnection of the first communication channel and a transfer of the connection of the first communication channel from the first communication channel to the second communication channel.

17. The electronic system of claim 16, wherein the operations further comprise:
receiving, from the device used by the first service provider, information indicative of a selection of one of the one or more available second service providers.

18. The electronic system of claim 16, wherein one or more of the device used by the consumer of services, the device used by the first service provider, and the device used by the second service provider comprises a telephonic device.

19. The electronic system of claim 16, wherein one or more of the device used by the consumer of services, the device used by the first service provider, and the device used by the second service provider comprises a computing device.

20. The electronic system of claim 16, wherein one or more of the first communication channel and the second communication channel comprises a voice-based communication channel.
